(19) United States
(12) Patent Application Publication
(10) Pub. No.: US 2026/0279931 A1
(43) Pub. Date: Sep. 17, 2026

(54) CIRCUIT ROUTING IN IMMERSION-COOLED BATTERY

(71) Applicant: Ford Global Technologies, LLC, Dearborn, MI (US)

(72) Inventors: Mihir Devendra Upadhye, Ann Arbor, MI (US); Liam E. West, Ferndale, MI (US); Jie Deng, Novi, MI (US)

(21) Appl. No.: 19/081,988

(22) Filed: Mar. 17, 2025

(51) Int. Cl. H01M 10/42; H01M 10/48; H01M 10/613; H01M 10/6568; H01M 50/284

(52) U.S. Cl. CPC H01M 10/4257; H01M 10/486; H01M 10/613; H01M 10/6568; H01M 50/284

(57) ABSTRACT

Immersion-cooled battery assemblies and systems with circuitry routed away from cooling channels are provided herein. In one example approach, a battery assembly is provided that comprises: a battery cell stack having a top surface, a bottom surface, a first side surface and a second side surface; a first endplate covering the first side surface and a second endplate covering the second side surface; and sensing circuitry routed along the first endplate or the second endplate, the sensing circuitry positioned in a first grooved path in the first endplate or a second grooved path in the second endplate.

### TECHNICAL FIELD

The present disclosure relates to battery cooling.

### BACKGROUND AND SUMMARY

In immersion-cooling approaches to lithium-ion battery cooling, routing of the cell voltage/temperature sensing circuitry may be more difficult, such as, for example, freeing the top surface of the cells for intimate contact with the flowing coolant. Alternatively, including sensing circuitry at such a location can potentially affect the coolant flow path and therefore cooling efficiency.

Immersion-cooled battery assemblies and systems with circuitry routed away from cooling channels are provided herein. In one example approach, a battery assembly is provided that comprises: a battery cell stack having a top surface, a bottom surface, a first side surface and a second side surface; a first endplate covering the first side surface and a second endplate covering the second side surface; and sensing circuitry routed along the first endplate or the second endplate, the sensing circuitry positioned in a first grooved path in the first endplate or a second grooved path in the second endplate. In some examples, such battery assemblies may further comprise an enclosure positioned over the top surface and the bottom surface of the battery cell stack, wherein the enclosure contains a cooling fluid in contact with the top surface and the bottom surface of the battery cell stack.

In the approaches described herein, sensing circuitry (e.g., cell voltage and temperature sensing circuitry) may be included in an immersion-cooled battery without substantially impeding flow of coolant around the battery cells. The approaches described herein may additionally offer advantages on cost or packaging efficiency by incorporating the circuitry into existing components within the design, e.g., by incorporating it into endplates or the enclosure top of a battery.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example electric vehicle with a battery.

FIG. 2 shows an illustration of an example bipolar battery cell.

FIG. 3 shows an illustration of an example monopolar battery cell.

FIG. 4 shows an example cold plate-based battery.

FIG. 5 shows an exploded view of an example immersion cooled battery assembly.

FIG. 6 show an example cross-sectional view of an example immersion cooled battery assembly.

FIG. 7 shows an exploded view of another example immersion cooled battery assembly.

FIG. 8 show an example cross-sectional view of another example immersion cooled battery assembly.

### DETAILED DESCRIPTION

The following description relates to immersion-cooled battery assemblies and systems with circuitry routed away from cooling channels.

Pouch cells may be used in such systems, where the pouch cells may be a flexible, flat pouch-shaped design. Pouch cells may be constructed using a flexible, multilayered laminate structure that comprises anodes, cathodes, and separators. The flexible pouch may be sealed, forming a single, compact unit. Additionally, the flexible design of pouch cells may allow for greater design flexibility and may accommodate irregular shapes and sizes.

Pouch cells of lithium-ion batteries may include cooling and thermal regulation features in order to reduce excessive heat generation during charging and discharging that can significantly degrade performance and shorten lifespan of the battery. In a pouch cell, voltage sensing features may be included to monitor the electrical potential across the cell to determine its state of charge (SOC), and temperature sensing features may be included to measure internal temperatures for ensuring safe and optimal battery operation by detecting potential issues like overheating or excessive discharge, which can be triggered by extreme temperatures or voltage levels, for example.

In some approaches, cold plates may be included in a pouch cell to provide cooling. In such approaches the cold plate may only be in contact with a single surface of the battery cells (e.g., a bottom surface of the cells). In such designs, the sensing circuitry (e.g., voltage & temperature sensing circuitry which may be in the form of a printed circuit board) may be placed on the top surface of the cells when the cold plate is only in contact with the bottom of the cells. Since cold plate cooling approaches may only provide cooling to a single surface of the cells, such approaches may not be as effective as immersion cooling, where the battery cells are almost entirely submerged in a cooling fluid. In an immersion-cooled pouch-cell battery array, coolant may contact the bottom and top of the cells to fully capitalize on the thermal performance enhancements of the technology. In the approaches described herein, sensing circuitry (e.g., cell voltage and temperature sensing circuitry) may be included in an immersion-cooled battery without substantially impeding flow of coolant around the battery cells. The approaches described herein may additionally offer advantages on cost or packaging efficiency by incorporating the circuitry into existing components within the design, e.g., by incorporating it into endplates or the enclosure top of a battery.

In some examples, sensing circuitry may cross over the battery cells within a module in order to access the busbars for voltage sensing, which may be on both ends of the module in a pouch-cell design. For example, whenever cell tabs are located at two sides of a battery cell, the sensing circuitry may extend from one side of the cell to the other.

In an immersion-cooled pouch-cell battery array, coolant may contact the bottom and top of the cells to fully capitalize on the thermal performance enhancements of the technology. Thus, in immersion-cooling approaches, conventional routing of the cell voltage/temperature sensing circuitry may not be feasible, as the top surface of the cells may have to be free for intimate contact with the flowing coolant. If the sensing circuitry is included on the top of the cells, then it can potentially change the coolant flow path and therefore affect its cooling efficiency.

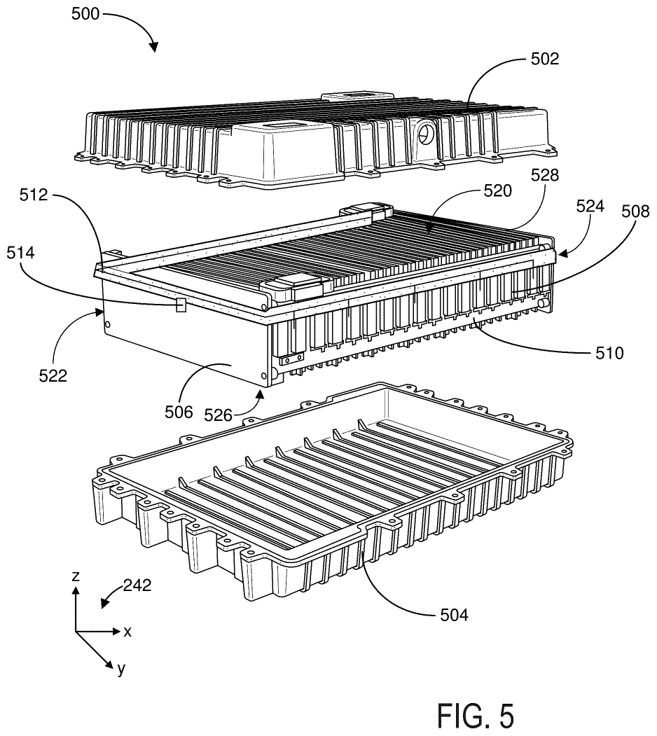

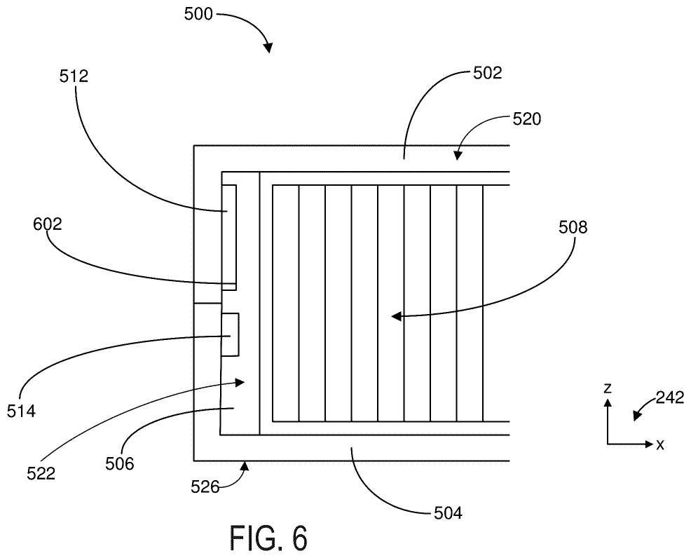

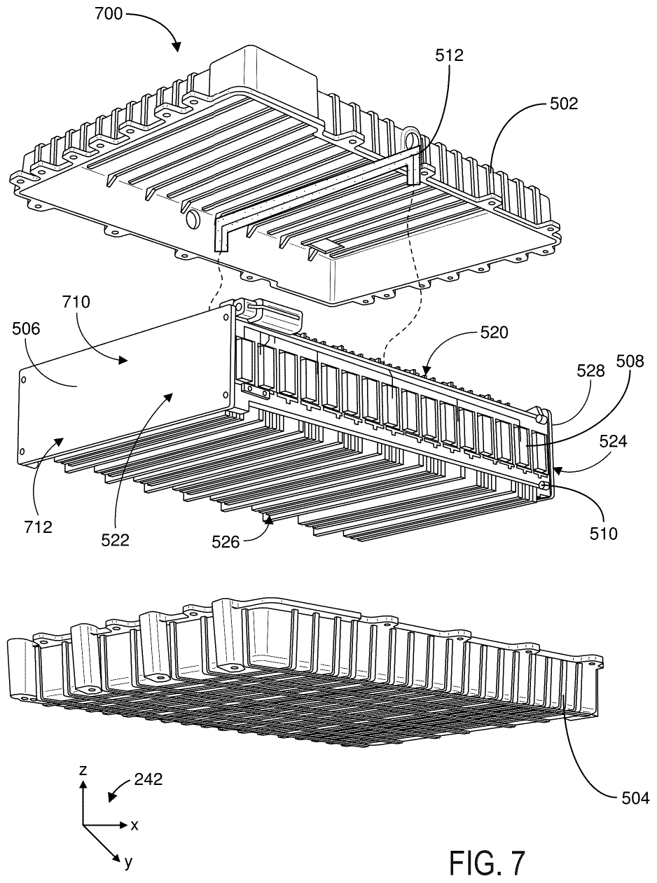

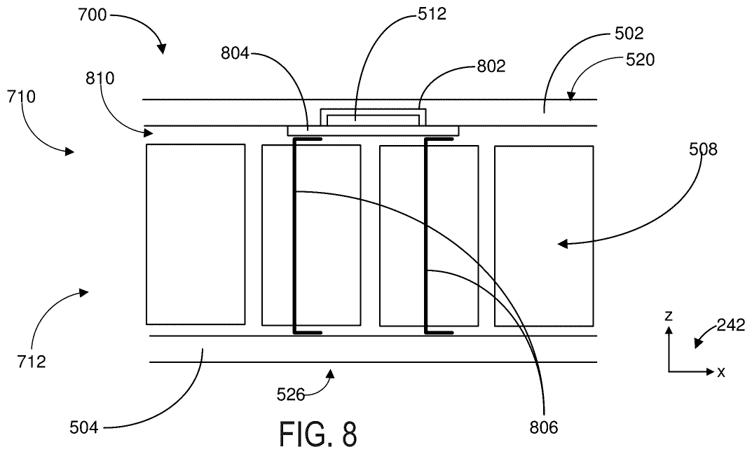

Examples are described herein for immersion-cooled battery systems and assemblies that route cell voltage/temperature sensing circuitry from one end of the module to the other while not impeding the coolant flow path. In one example approach (illustrated in FIGS. 5 and 6 described below), sensing circuitry may be routed along the edge of the cell stack, as opposed to conventional top-routing. In another example approach (illustrated in FIGS. 7 and 8 described below), the sensing circuitry may be incorporated into the top case of the enclosure.

It is to be understood that the specific assemblies and systems illustrated in the attached drawings, and described in the specification are example embodiments of the inventive concepts defined herein. For purposes of discussion, the drawings may be described collectively. Thus, like elements may be commonly referred to herein with like reference numerals and may not be re-introduced.

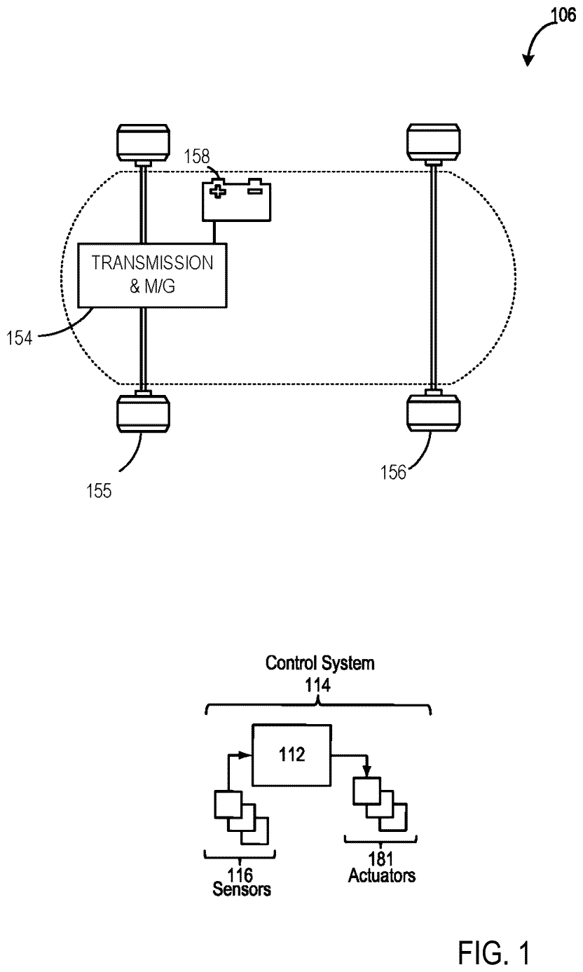

Turning now to the figures, FIG. 1 shows a schematic depiction of an example vehicle system 106 that can derive propulsion power from an electric motor 154 (e.g., a drive motor). As used herein, the terms “electric vehicle” or “EV” is intended to mean any suitable vehicle that is at least partially configured to be propelled using electric power, e.g., via one or more electric motors incorporated in the vehicle. For example, vehicle system 106 may be considered to be an electric vehicle (EV). Though FIG. 1 shows a single electric motor 154, it should be understood that vehicle system 106 may include any suitable number of electric motors to propel the vehicle and/or provide power to various components and systems within system 106. In some examples, electric motor 154 may be a traction motor, however other types of electric motors are contemplated. Electric motor 154 may receive electrical power from a battery 158 to provide torque to vehicle wheels 155. Electric motor 154 may also be operated as a generator to provide electrical power to charge battery 158, for example, during a braking operation. In some examples, battery 158 may comprise a solid-state battery (SSB).

It should be appreciated that while FIG. 1 depicts an electric motor 154 mounted in a rear wheel drive configuration, other configurations are possible, such as employing electric motor 154 in a front wheel configuration, or in a configuration in which there is an electric motor mounted to both the rear vehicle wheels 155 and front vehicle wheels 156. Further, additional electric motors may be included in system 106.

Electric motor 154 may include a gearbox integrated therein and/or may provide input power, together with other electric motors, to a transmission system. Additionally, or alternatively, the electric motor 154 may be coupled to an outside of a transmission/gearbox housing. The integrated gearbox may include one or more input speed reduction gear sets. Electric motor 154 may also include at least one clutch. Controller 112 may send a signal to an actuator of the clutch(es) to engage or disengage the clutch(es), so as to couple or decouple power transmission from the electric motor 154 to the rear vehicle wheels 155 or the front vehicle wheels 156. Additionally, or alternatively, there may be multiple batteries configured to provide power to different driven wheels, wherein power to the wheels may be predicated based on traction at the wheels, driver demand, and other conditions.

Controller 112 may form a portion of a control system 114. Control system 114 is shown receiving information from a plurality of sensors 116 and sending control signals to a plurality of actuators 181. As one example, sensors 116 may include sensors such as a battery level sensor, clutch activation sensor, etc. As another example, the actuators may include the clutch, etc. The controller 112 may receive input data from the various sensors, process the input data, and trigger the actuators in response to the processed input data based on instructions or code programmed therein corresponding to one or more routines.

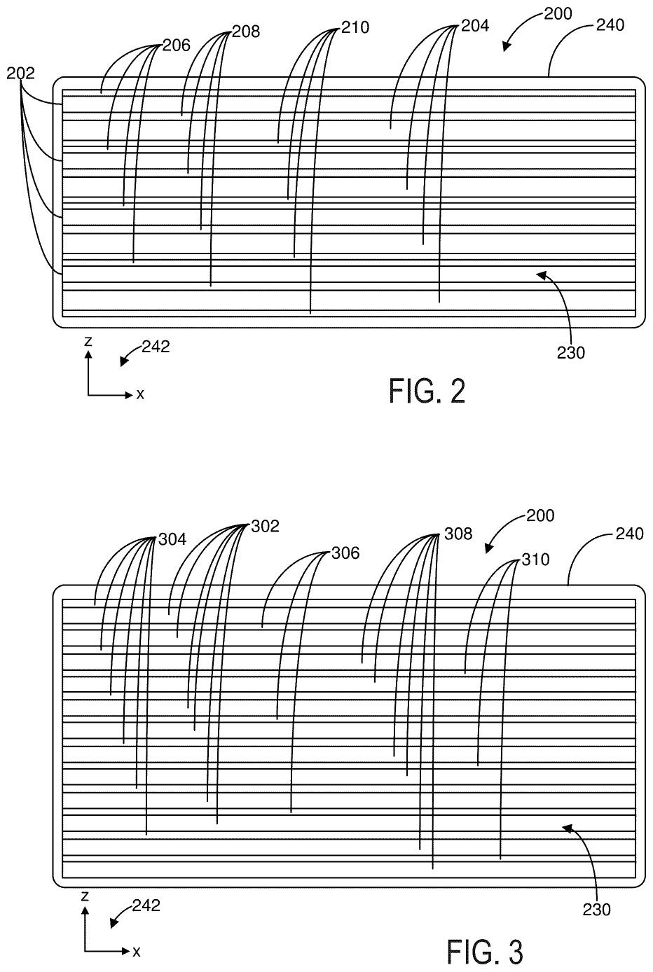

Turning now to FIGS. 2-8, various views of example battery assemblies and systems are shown. An axis system 242 is provided in the FIGS. 2-8 for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

FIG. 2 shows a cross-sectional view of example battery 200 with an electrode stack 230 enclosed in a pouch 240. The example battery shown in FIG. 2 has a bipolar cell structure (an example battery with monopolar cell structure is shown in FIG. 3, where like elements use like numbering). Pouch 240 may form a container, a pocket or a cavity which houses the electrode assembly including the electrode stack 230. In some embodiments, the pouch 240 may comprise a porous plastic tube, pouch, or sleeve made of any suitable material. Stack 230 comprises a plurality of electrodes and other components of a battery, such as electrode coatings, current collectors, separators, etc. For example, as shown in FIG. 2, electrode stack 230 comprises a plurality of anodes 202 (i.e., negatively charged electrodes) and a plurality of cathodes 204 (i.e., positively charged electrodes) arranged in a stack formation. Each anode may have an anode current collector 206 (i.e., an anode electrical contact) that is in contact with a surface of the anode. Each cathode may have a cathode current collector 210 (i.e., a cathode electrical contact) that is in contact with a surface of the cathode. The anodes and cathodes included in stack 230 may have various coatings disposed thereon in some examples. Separator 208 may be disposed between the anodes and cathodes.

Battery 200 may comprise a solid-state battery. A solid-state battery is an electrical battery that uses a solid electrolyte for ionic conductions between the electrodes, instead of liquid or gel polymer electrolytes found in conventional batteries. Solid-state batteries may provide higher energy density than the typical lithium-ion or lithium polymer batteries. The cathodes 204 (i.e., positive electrodes) may be made with the same compounds as a lithium-ion battery (e.g., LFP, NMC, LMO, etc). The anodes 202 (i.e., negative electrodes) may be made of lithium metal (e.g., pure lithium) in some examples. In some examples, a negative electrode may be formed by coating a negative electrode active material such as a lithium metal, a lithium alloy, carbon, petroleum coke, activate carbon, graphite, silicon, silicon oxide, silicon composite, titanium-based material, or the like, on both surfaces of a negative electrode current collector made of copper, nickel, a copper alloy, other potential conductive materials, or any combination thereof. Also, a positive electrode may be formed by coating a positive electrode active material such as a lithium manganese oxide, a lithium cobalt oxide, a lithium nickel oxide, or the like, on both surfaces of a positive electrode current collector made of aluminum, nickel, other potential conductive materials, or a combination thereof.

As illustrated in FIG. 2, the negative electrodes 202 and the positive electrodes 204 may be stacked with separators 208. The separators 208 may be comprised of a ceramic material (e.g., oxides, sulfides, phosphates), or a solid polymer, which also functions as the electrolyte. It therefore becomes the medium through which the ions move and also has electric insulating properties and functions as a mechanical separator between the anodes and cathodes. The solid electrolyte may function as an ideal separator that allows only lithium ions to pass through. For that reason, solid-state batteries can potentially solve many problems of currently used liquid electrolyte Li-ion batteries, such as flammability, limited voltage, unstable solid-electrolyte interface formation, poor cycling performance, and strength. The separators may be made of a material generally used in the art. For example, a multi-layer film made of polyethylene, polypropylene, or a combination thereof having a microporous structure, or a polymer film for a gel-type polymer electrolyte or a solid polymer electrolyte such as polyvinylidene fluoride, polyethylene oxide, polyacrylonitrile, or polyvinylidene fluoride hexafluoropropylene copolymer may be used.

FIG. 3 shows a cross-sectional view of an example battery 200 with a monopolar cell structure. Like-numbered elements shown in FIG. 3 correspond to like-numbered elements shown in FIG. 2 described above. The example monopolar electrode stack 230 shown in FIG. 3 comprises an anode layer that comprises separators 304 that form boundaries to anode coatings 302 on top and bottom surfaces of anode current collectors 306. The cathode layers in this example comprise cathode coatings 308 on top and bottom surfaces of cathode current collectors 310.

The electrodes and other components in the electrode stacks 230 shown in FIGS. 2 & 3 may be laminated together to affix all the components together. Lamination is a technique/process of manufacturing a material in multiple layers. A laminate is a layered object or material that may be assembled using heat, pressure, welding, or adhesives. Various coating machines, machine presses and/or calendering equipment may be used to laminate the layers in the electrode stacks 230.

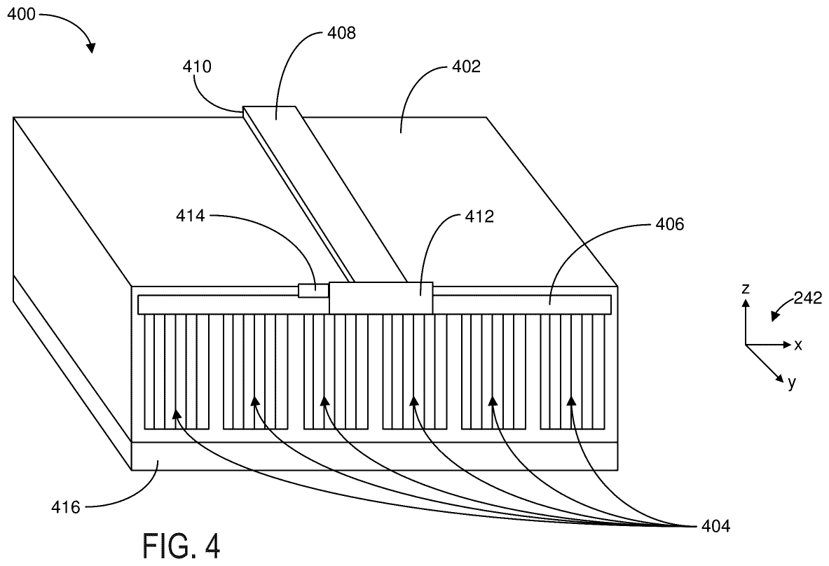

FIG. 4 shows an example cold plate-based battery assembly 400. The example battery shown in FIG. 4 comprises a plurality of battery cells 404 contained within an enclosure 402. The battery cells shown in FIG. 4 may be lithium-ion or solid-state battery cells (e.g., monopolar or bipolar battery cells). A cold plate 416 may be positioned along the bottom surface of the battery to provide cooling to the battery. The cold plate may comprise a component that is configured to remove heat from the battery during use. For example, cold plate 416 may comprise a thermoelectric cold plate (e.g., Peltier cold plate), a liquid-cooled cold plate or the like. For example, cold plate 416 may comprise an embedded tube cold plate, a brazed cold plate, a bonded fin cold plate, a hybrid cold plate, a microchannel cold plate or a composite cold plate.

Embedded tube cold plates may comprise a metal base (typically copper or aluminum) with tubes embedded within through which coolant flows. Brazed cold plates may be constructed by stacking multiple thin metal sheets (usually copper or aluminum) and brazing them together to form intricate liquid channels for cooling. Extruded cold plates may be manufactured by extruding aluminum or copper into specific shapes with internal channels for the coolant. Bonded fin cold plates may use a base plate with fins bonded to it, increasing the surface area for heat transfer. Hybrid cold plates may combine different cooling technologies to achieve optimal performance. For instance, a hybrid design might integrate stamped channels with microchannels to enhance thermal performance while maintaining cost-effectiveness. Microchannel cold plates may have tiny channels etched or machined into the plate, allowing coolant to flow through these microchannels. Composite cold plates may utilize a combination of metals and non-metals, such as graphite or carbon fiber, to create a lightweight yet highly efficient cooling solution.

In the example shown in FIG. 4, since the cold plate is at the bottom of the battery, sensing circuitry 408 may be routed along the top of the battery above the cells. For example, the sensing circuitry may comprise a flexible printed circuit board (FPCB) and the circuitry 408 may wrap around busbars (e. g., busbar 406) and a low-voltage connector 412 which takes the signals to a battery energy control module included in the battery system.

As illustrated in FIG. 4, a thermistor 414 (or other suitable temperature sensor) may be incorporated into the circuitry for intimate contact with the battery cell top surface. The thermistor 414 may be used to monitor the temperature of the battery cells and, in some examples, adjust operational parameters of the battery based on the monitored temperatures.

As remarked above and as shown in FIG. 4, the cold plate 416 may only be in contact with the bottom surface of the battery cells 404. In such designs, the sensing circuitry (e.g., voltage & temperature sensing circuitry which may be in the form of a printed circuit board) may be placed on the top surface of the cells when the cold plate is only in contact with the bottom of the cells. Since cold plate cooling approaches may only provide cooling to a single surface of the cells, such approaches may not be as effective as immersion cooling, where the battery cells are almost entirely submerged in a cooling fluid.

As shown in FIG. 4 the sensing circuitry 408 may cross over the battery cells within a module in order to access the busbars (e.g., busbar 406) for voltage sensing, which may be on both ends of the module in a pouch-cell design. For example, whenever cell tabs are located at two sides of a battery cell, the sensing circuitry may extend from one side of the cell to the other. Additionally, there may be a gap 410 between the cell top surface and the sensing circuitry 408. The gap 410 may be in a range of about 1-2 mm, which is too close for immersion cooled applications which may use a coolant channel height of about 4-6 mm.

In contrast to the example shown in FIG. 4 with cold plate cooling, in an immersion-cooled pouch-cell battery array, coolant may contact the bottom and top of the cells to fully capitalize on the thermal performance enhancements of the technology. Thus, in immersion-cooling approaches, conventional routing of the cell voltage/temperature sensing circuitry may not be feasible, as the top surface of the cells may have to be free for intimate contact with the flowing coolant. If the sensing circuitry is included on the top of the cells, then it can potentially change the coolant flow path and therefore affect its cooling efficiency. However, by locating the sensing circuitry at alternate locations in the battery assembly (such as shown in FIGS. 5-8 described below), immersion cooling approaches may be used to provide thermal management to a battery.

FIG. 5 shows an exploded view of an example immersion cooled battery assembly 500, where the sensing circuitry 512 is routed along a grooved edge of the cell stack as opposed to conventional top-routing, such as shown in FIG. 4. In the approach shown in FIG. 5, the cell voltage/temperature sensing circuitry is routed from one end of the module to the other while not impeding the coolant flow path. In this example, this is accomplished by routing the sensing circuitry around the outer side perimeter of the battery cell stack. FIG. 6 shows a cross-sectional view of the example immersion cooled battery configuration 500 shown in FIG. 5. Like-numbers in FIGS. 5 and 6 correspond to like elements.

In this example, the battery assembly 500 comprises a battery cell stack 508 having a top surface 520, a bottom surface 526, a first side surface 522 and a second side surface 524. The battery cell stack may comprise a lithium-ion or solid-state battery cell stack. In some examples, the battery cell stack 508 may comprise a bipolar battery cell (e.g., as shown in FIG. 2 described above). In other examples, the battery cell stack 508 may comprise a monopolar battery cell stack (e.g., as shown in FIG. 3 described above). In some examples, the battery cells 508 may be connected to one or more busbars in the battery assembly. For example, battery cells 508 may be in electrical communication with busbars 510.

Battery assembly 500 additionally comprises a first endplate 506 covering the first side surface 522 and a second endplate 528 covering the second side surface 524. The endplates 506 and 528 (also called wedge plates) may be used to transmit cell swelling force to the enclosure of the battery assembly (e.g., to the enclosure formed from the top enclosure 502 and the bottom enclosure 504). In order to reduce impact of cell swelling force on the sensing circuitry, grooves in the endplates may be added and the circuity may be disposed in the grooves. For example, sensing circuitry 512 may be routed along the first endplate 506 or the second endplate 528. The sensing circuitry 512 may be positioned in a first grooved path 602 in the first endplate 506 or a second grooved path in the second endplate 528. The grooves in the endplates within which the circuitry is included may comprise cut-outs that are sized to accommodate the sensing circuitry. These cut-outs or grooves in the side plates may be formed on the exterior sides (i.e., the side or surface of the endplate that is opposite to the side of the endplate that faces the battery cells 508). The sensing circuitry 512 may be positioned within the battery assembly at locations that do not overlap with the top surface 520 or the bottom surface 526 of the battery cell stack 508, so that the sensing circuitry does not impede coolant flow over the top or bottom surfaces of the battery cells.

The sensing circuitry 512 may comprise a printed circuit board (PCB) or a flexible printed circuit board (FPCB). The sensing circuitry 512 may comprise a temperature sensor and a voltage sensor incorporated into or connected to the circuitry. In some examples, the temperature sensor included in or connected to the circuitry may comprise a thermistor, such as thermistor 514 shown in FIGS. 5 and 6. The thermistor 514 may be positioned on the first endplate 506 or the second endplate 528. In some examples, the thermistor 514 may be positioned in a groove or cutout in one of the endplates, so that it is not affected by cell swelling forces on the endplates. For example, thermistor 514 may be positioned in a groove on an external surface or side of one of the endplates (i.e., the side of the endplate opposite the battery cells). The thermistor 514 may be integrated into and/or electrically connected to the sensing circuitry.

The battery assembly 500 further comprising an enclosure. The enclosure comprises an enclosure top 502 and an enclosure bottom 504 that, when assembled around the battery cells, form the enclosure. The enclosure top 502 may be positioned over the top surface 520 of the battery cells 508 and the enclosure bottom may be positioned over the bottom surface 526 of the battery cell stack 508. When assembled over the battery cells 508, the enclosure formed from top enclosure 502 and bottom enclosure 504 may form a fluidically-sealed cavity or chamber through which a coolant fluid (e.g., a suitable dielectric fluid) may flow. In particular, the enclosure formed from top enclosure 502 and bottom enclosure 504 may be fluidically sealed over the top surface 520 and the bottom surface 526 of the battery cell stack 508. The enclosure formed from top enclosure 502 and bottom enclosure 504 may contain a cooling fluid in contact with the top surface 520 and the bottom surface 526 of the battery cell stack 508. In some examples, a height of the space/cavity/chamber formed between the top surface 520 of the battery cells 508 and the top enclosure 502 may be in an inclusive range of about 4-6 mm. Likewise, in some examples, a height of the space/cavity/chamber formed between the bottom surface 526 of the battery cells 508 and the bottom enclosure 504 may be in an inclusive range of about 4-6 mm. However, other space/cavity/chamber heights are contemplated. For example, the heights of these spaces/cavities/chambers may be greater than about 3 mm, or may be in an inclusive range of about 3-6 mm, or 2-6 mm, or 4-7 mm, or greater than about 4 mm, etc. Coolant may flow along the coolant channels formed around the battery cells by the enclosure to provide thermal management to the battery assembly.

The battery assembly 500 shown in FIGS. 5 and 6 may be efficient for packaging as it allows the combination of separate parts (e.g., a FPCB & end plate) which can be beneficial for packaging efficiency. Further, this placement can allow for intimate contact of the thermistor with/adjacent to the cell at the end of the stack.

FIG. 7 shows an exploded view of another example immersion cooled battery assembly 700, where the sensing circuitry 512 is routed along an interior surface or top portion of the enclosure in the battery assembly 700. In this approach, the sensing circuitry is essentially lifted above the top surface 520 of the battery cells 508 so that coolant can flow over the top surface of the battery cells without being impeded by the circuitry. FIG. 8 show a cross-sectional view of immersion cooled battery assembly 700 shown in FIG. 7. Like-numbers in FIGS. 5-8 correspond to like elements.

In this example, the battery assembly 700 comprises a battery cell stack 508 having a top surface 520, a bottom surface 526, a first side surface 522 and a second side surface 524. As in the previous example, battery assembly 700 includes wedge plates or end plates 506 and 528 at opposing sides of the battery cell stack 508 that are used to transmit cell swelling force to the enclosure. In this example, the enclosure is formed from a first half of the enclosure 502 (i.e., top enclosure) and a second half of the enclosure 504 (i.e., bottom enclosure). The first half of the enclosure 502 is configured to accommodate a first portion 710 (e.g., a top half portion) of the battery cell stack 508. The second half of the enclosure 504 is configured to accommodate a second portion 712 (e.g., a bottom half portion) of the battery cell stack 508. In some examples, the battery cells 508 may be connected to one or more busbars in the battery assembly. For example, battery cells 508 may be in electrical communication with busbars 510.

In this example, the sensing circuitry 512 is incorporated into the first half of the enclosure 502. In particular, routing of the cell voltage/temperature sensing circuitry is incorporated into the module's upper enclosure top, thereby keeping the circuitry away from the top of the cells so as not to impede coolant flow over the top of the cells. In this example, the sensing circuitry 512 may be positioned in a groove 802 in the first half of the enclosure 502. For example, a groove or cut-out may be formed on an interior surface of the first half of the enclosure 502, where the groove or cut-out is configured to accommodate the sensing circuitry 512. In some examples, as shown in FIG. 8, the sensing circuitry 512 may be positioned on a sensing circuitry frame 804, where the sensing circuitry frame comprises a platform that is configured to hold the sensing circuitry in place. One or more structural fins 806 positioned between the first half of the enclosure 502 and the second half of the enclosure 504 may be included to support the sensing circuitry frame 804. The frame that supports the sensing circuitry 512 can be added on top of the structural fins, which allows coolant to flow between the circuitry and the cell top surface, effectively mitigating flow impediment.

In this example, the first half of the enclosure 502 forms a cooling channel 810 above a top surface 520 of the battery cell stack 508 and the sensing circuitry 512 may be positioned so as not to come into contact with coolant in the cooling channel 810. When assembled over the battery cells 508, the enclosure formed from first half of the enclosure 502 and second half of the enclosure 504 may form a fluidically-sealed cavity or chamber through which a coolant fluid (e.g., a suitable dielectric fluid) may flow. In particular, the enclosure may be fluidically sealed over the top surface 520 and the bottom surface 526 of the battery cell stack 508. In some examples, a height of the space/cavity/chamber formed between the top surface 520 of the battery cells 508 and the first half of the enclosure 502 may be in an inclusive range of about 4-6 mm. Likewise, in some examples, a height of the space/cavity/chamber formed between the bottom surface 526 of the battery cells 508 and the second half of the enclosure 504 may be in an inclusive range of about 4-6 mm. However, other space/cavity/chamber heights are contemplated. For example, the heights of these spaces/cavities/chambers may be greater than about 3 mm, or may be in an inclusive range of about 3-6 mm, or 2-6 mm, or 4-7 mm, or greater than about 4 mm, etc. Coolant may flow along the coolant channels formed around the battery cells by the enclosure to provide thermal management to the battery assembly.

The battery assembly 700 shown in FIGS. 7 and 8 is configured to keep the sensing circuitry out of the cell stack and therefore may not need to be protected from cell swelling force, and therefore may be beneficial for cost. In the battery assemblies shown in FIGS. 5-8, sensing circuitry (e.g., cell voltage and temperature sensing circuitry) may be included in an immersion-cooled battery without substantially impeding flow of coolant around the battery cells. The approaches described herein may additionally offer advantages on cost or packaging efficiency by incorporating the circuitry into existing components within the design, e.g., by incorporating it into endplates or the enclosure top of a battery.

FIGS. 1-8 are drawn approximately to scale, aside from the schematically depicted components. However, the components may have other relative dimensions, in other embodiments. The figures show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such.

The invention will be further described in the following paragraphs. In one aspect, a battery assembly is provided that comprises: a battery cell stack having a top surface, a bottom surface, a first side surface and a second side surface; a first endplate covering the first side surface and a second endplate covering the second side surface; and sensing circuitry routed along the first endplate or the second endplate, the sensing circuitry positioned in a first grooved path in the first endplate or a second grooved path in the second endplate. In some examples, the sensing circuitry may not overlap with the top surface or the bottom surface of the battery cell stack. In some aspects, the battery cell stack may comprise a lithium-ion or solid-state battery cell stack.

In additional aspects, the battery assemblies provided herein may further comprise an enclosure positioned over the top surface and the bottom surface of the battery cell stack. For example, the enclosure may be fluidically sealed over the top surface and the bottom surface of the battery cell stack. In some examples, the enclosure may contain a cooling fluid in contact with the top surface and the bottom surface of the battery cell stack. For example, the cooling fluid may comprise a dielectric fluid or the like.

In some aspects, the sensing circuitry included in the battery assemblies provided herein may comprise a flexible printed circuit board. In some examples, the sensing circuitry may comprise a temperature sensor and a voltage sensor. For example, the temperature sensor may comprise a thermistor. In some examples, battery assemblies provided herein may further comprise a thermistor positioned on the first endplate or the second endplate.

In additional aspects, a solid-state battery assembly is provided herein that comprises: a solid-state battery cell stack having a top surface, a bottom surface, a first side surface and a second side surface; a first endplate covering the first side surface and a second endplate covering the second side surface; sensing circuitry routed along the first endplate and the second endplate, the sensing circuitry positioned in a first grooved path in the first endplate and a second grooved path in the second endplate; and an enclosure positioned over the top surface and the bottom surface of the battery cell stack, wherein the enclosure is fluidically sealed over the top surface and the bottom surface of the battery cell stack. In some examples, the enclosure may contain a cooling fluid in contact with the top surface and the bottom surface of the battery cell stack. In some examples, the sensing circuitry may comprise a flexible printed circuit board. In some examples, the sensing circuitry may comprise a temperature sensor and a voltage sensor.

In additional aspects, a battery assembly is provided herein that comprises: a battery cell stack; a first half of an enclosure configured to accommodate a first portion of the battery cell stack; a second half of the enclosure configured to accommodate a second portion of the battery cell stack; and sensing circuitry incorporated into the first half of the enclosure. In some aspects, the sensing circuitry may comprise a flexible printed circuit board. In additional aspects, the sensing circuitry may comprise a temperature sensor and a voltage sensor. In some examples, the sensing circuitry may be positioned in a groove in the first half of the enclosure. In additional aspects, the sensing circuitry may be positioned on a sensing circuitry frame. In further aspects, the battery assemblies provided herein may further comprise: one or more structural fins positioned between the first half of the enclosure and the second half of the enclosure, wherein the structural fins are configured to support the sensing circuitry frame. In some examples, the first half of the enclosure may form a cooling channel above a top surface of the battery cell stack. In some examples, the sensing circuitry may not come into contact with a coolant in the cooling channel.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery assembly comprising:
a battery cell stack having a top surface, a bottom surface, a first side surface and a second side surface;
a first endplate covering the first side surface and a second endplate covering the second side surface; and
sensing circuitry routed along the first endplate or the second endplate, the sensing circuitry positioned in a first grooved path in the first endplate or a second grooved path in the second endplate.

2. The battery assembly of claim 1, wherein the sensing circuitry does not overlap with the top surface or the bottom surface of the battery cell stack.

3. The battery assembly of claim 1, wherein the battery cell stack comprises a lithium-ion or solid-state battery cell stack.

4. The battery assembly of claim 1, further comprising an enclosure positioned over the top surface and the bottom surface of the battery cell stack.

5. The battery assembly of claim 4, wherein the enclosure is fluidically sealed over the top surface and the bottom surface of the battery cell stack.

6. The battery assembly of claim 5, wherein the enclosure contains a cooling fluid in contact with the top surface and the bottom surface of the battery cell stack.

7. The battery assembly of claim 6, wherein the cooling fluid comprises a dielectric fluid.

8. The battery assembly of claim 1, wherein the sensing circuitry comprises a flexible printed circuit board.

9. The battery assembly of claim 1, wherein the sensing circuitry comprises a temperature sensor and a voltage sensor.

10. The battery assembly of claim 9, wherein the temperature sensor comprises a thermistor.

11. The battery assembly of claim 1, further comprising a thermistor positioned on the first endplate or the second endplate.

12. A solid-state battery assembly comprising:
a solid-state battery cell stack having a top surface, a bottom surface, a first side surface and a second side surface;
a first endplate covering the first side surface and a second endplate covering the second side surface;
sensing circuitry routed along the first endplate or the second endplate, the sensing circuitry positioned in a first grooved path in the first endplate or a second grooved path in the second endplate; and
an enclosure positioned over the top surface and the bottom surface of the battery cell stack, wherein the enclosure is fluidically sealed over the top surface and the bottom surface.

13. The battery assembly of claim 12, wherein the enclosure contains a cooling fluid in contact with the top surface and the bottom surface of the battery cell stack.

14. The battery assembly of claim 12, wherein the sensing circuitry comprises a flexible printed circuit board.

15. A battery assembly comprising:
a battery cell stack;
a first half of an enclosure configured to accommodate a first portion of the battery cell stack;
a second half of the enclosure configured to accommodate a second portion of the battery cell stack; and
sensing circuitry incorporated into the first half of the enclosure.

16. The battery assembly of claim 15, wherein the sensing circuitry comprises a flexible printed circuit board.

17. The battery assembly of claim 15, wherein the sensing circuitry is positioned in a groove in the first half of the enclosure.

18. The battery assembly of claim 15, wherein the sensing circuitry is positioned on a sensing circuitry frame.

19. The battery assembly of claim 18, further comprising one or more structural fins positioned between the first half of the enclosure and the second half of the enclosure, wherein the structural fins are configured to support the sensing circuitry frame.

20. The battery assembly of claim 15, wherein the first half of the enclosure forms a cooling channel above a top surface of the battery cell stack.
